(19) United States
(12) Patent Application Publication
(10) Pub. No.: US 2018/0103005 A1
(43) Pub. Date: Apr. 12, 2018

(54) SYSTEMS AND METHODS TO PROMPT PAGE ADMINISTRATOR ACTION BASED ON MACHINE LEARNING

(71) Applicant: Facebook, Inc., Menlo Park, CA (US)

(72) Inventors: Ashish Kumar Yadav, Mountain View, CA (US); Komal Kapoor, Bellevue, WA (US); Daniel Dinu, Sunnyvale, CA (US); Bradley Ray Green, Snohomish, WA (US); Naman Jain, Randolph, NJ (US)

(21) Appl. No.: 15/289,729

(22) Filed: Oct. 10, 2016

(51) Int. Cl. H04L 12/58

(52) U.S. Cl. CPC H04L 51/32; H04L 51/24

(57) ABSTRACT

Systems, methods, and non-transitory computer readable media are configured to receive values associated with features corresponding to an instance involving a page of a social networking system and an administrator of the page. The values associated with the features are applied to a machine learning model. A probability that the administrator of the page will take action on the page in response to receipt of an electronic notification provided to the administrator is determined based on the machine learning model.

### FIELD OF THE INVENTION

The present technology relates to the field of machine learning. More particularly, the present technology relates to techniques for determining the probability of actions to be taken on pages of a social networking system.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, a user may navigate to or be presented with various content items in a social network. The content items can come from pages associated with members of the social network. A page may have administrators that select the content items presented on the page and otherwise manage activities with the page. Actions taken by such administrators on the page can raise user interest in the page. Increased engagement with the page by both administrators and users can improve the effectiveness and quality of the page in the social network.

### SUMMARY

Various embodiments of the present technology can include systems, methods, and non-transitory computer readable media configured to receive values associated with features corresponding to an instance involving a page of a social networking system and an administrator of the page. The values associated with the features are applied to a machine learning model. A probability that the administrator of the page will take action on the page in response to receipt of an electronic notification provided to the administrator is determined based on the machine learning model.

In an embodiment, the machine learning model is trained based on the features, categories of the features comprising at least one timing of notifications last provided to the administrator, activities of the administrator on the page, and user interactions with the page.

In an embodiment, the electronic notification comprises a summary of user interactions with the page during a selected duration of time.

In an embodiment, the summary comprises a count of user interactions, the user interactions comprising at least one of likes by users of the page, likes by users of a content item on the page, views by users of the page, and comments by users on the page.

In an embodiment, the probability that the administrator of the page will take action on the page is based on a selected amount of time after receipt of the electronic notification.

In an embodiment, the action taken by the administrator comprises at least one of posting content on the page, publishing a comment on the page, expressing satisfaction with content posted by a user on the page, and communicating with a user who liked the page.

In an embodiment, the machine learning model is based on a boosted decision tree technique.

In an embodiment, an increase in the probability that the administrator of the page will take action on the page in response to receipt of an electronic notification that accounts for a user interaction with the page is determined.

In an embodiment, a rank score for the page is determined based at least in part on a value of the user interaction with the page, the value of the user interaction based on the increase in the probability.

In an embodiment, information about the page is presented as a page suggestion to the user when the rank score satisfies a threshold rank score.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example notification module and an example page recommendation system, according to an embodiment of the present technology.

FIG. 2 illustrates an example administrator activity probability module, according to an embodiment of the present technology.

FIG. 3 illustrates an example functional block diagram of an example application relating to suggestion of pages in a social networking system, according to an embodiment of the present technology.

FIG. 4 illustrates an example method to determine a probability that an administrator will take action on a page in response to receipt of an electronic notification, according to an embodiment of the present technology.

FIG. 5 illustrates an example method to present a page suggestion to a user, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Determining Probability That an Administrator Will Take Action on a Page

As referenced, under conventional approaches, a user may navigate to or be presented with various content items in a social networking system. The content items can come from pages associated with members of the social networking system. Members can include, for example, businesses, organizations, groups, individuals, etc. A page may have administrators that select the content items presented on the page and otherwise manage activities with the page. Actions taken by such administrators on the page can elevate user interest in the page and otherwise elevate the quality and effectiveness of the page in the social networking system.

One common challenge for a page on a social networking system is that an administrator associated with the page only occasionally or rarely takes action on the page. Such action by an administrator can include posting content on the page, publishing a comment on the page, expressing satisfaction (e.g., liking) with content posted on the page by a user who visited the page, communicating with a fan who liked the page, and the like. Such action, when taken by the administrator, can raise the level of interest of users in the page. The raised level of interest, in turn, can generate more interaction by the users with the page. Action by an administrator of the page and user interactions with the page can increase the relevance, effectiveness, and quality of the page in the social networking system.

Accordingly, when administrators take infrequent action on the page, the page can suffer. A conventional technique to address the problem is to transmit an instant electronic notification to an administrator each time and immediately after a predetermined user interaction with the page occurs. This type of electronic notification can be referred to as an organic notification. The intent of such electronic notifications is to notify the administrator about a recent activity in connection with the page and to prompt the administrator to take responsive action on the page. However, such electronic notifications often fail to prompt the desired action. As just one example, if a notification is transmitted to the administrator each time a user performs a certain type of action (e.g., fans the page), the relative importance of a single user action in relation to a large number of user actions already taken on the page can lack sufficient perceived importance to warrant action by the administrator.

An improved approach rooted in computer technology overcomes the foregoing and other disadvantages associated with conventional approaches specifically arising in the realm of computer technology. Systems, methods, and computer readable media of the present technology can apply a machine learning model to determine a probability that an administrator of a page will take action on the page in response to an electronic notification (inorganic notification) transmitted to the administrator. The notification, which can include a summary or digest of information relating to historical user interactions with the page, can be transmitted by a social networking system to the administrator. The machine learning model can be trained on a variety of features. Categories of features can include information relating to, for example, timing of electronic notifications last provided to the administrator, activities of the administrator on the page, user interactions with the page, profile of the page, etc. In an evaluation phase, based on instance involving an administrator and a page associated with the administrator, the machine learning model can determine the probability that the administrator will take action on the page in response to an electronic notification provided by the social networking system to the administrator. If the probability satisfies a probability threshold value, an electronic notification can be provided to the administrator to prompt the administrator to take action on the page. In some instances, a probability that the administrator will take action on the page can be applied in a page recommendation system that recommends pages to users of the social networking system. With respect to the page recommendation system, a page selected for recommendation to a user can be based at least in part on a value of a user interaction with the page presented with the recommendation, such as the user's liking (or fanning) the page. The value can be based on an increase in the probability that an administrator will take action on the page in response to the user interaction. More details regarding the present technology are described herein.

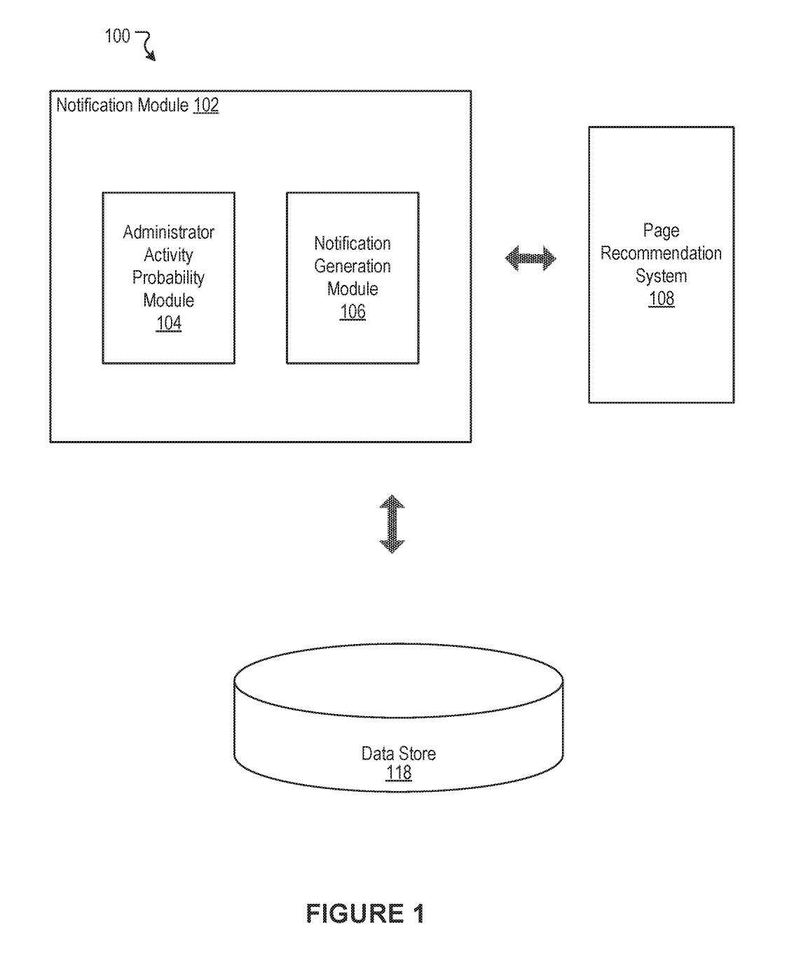

FIG. 1 illustrates an example system 100 including an example notification module 102 configured to transmit electronic notifications to an administrator of a page on a social networking system based on a determination of a probability that the administrator will be prompted to take action on the page in response to the electronic notification, according to an embodiment of the present technology. A page can be a domain, resource, or profile on the social networking system that is associated with a business, organization, group, or other entity who maintains a presence on the social networking system. Among other responsibilities, an administrator of a page can select and manage the content items posted on the page as well as communicate with users of the social networking system who have interacted with the page. Actions taken by an administrator on a page can include, for example, posting content on the page, publishing comments on the page, expressing satisfaction with (e.g., liking) content posted by users who have visited the page, and the like. When an electronic notification to an administrator succeeds in prompting action by the administrator on the page, more user interactions can result. Increased engagement in the form of actions taken by the administrator on the page and user interactions with the page can raise the quality and effectiveness of the page on the social networking system.

The notification module 102 can include an administrator activity probability module 104 and a notification generation module 106. The notification module 102 can communicate with a page recommendation system 108. Based on the notification module 102, the page recommendation system 108 can recommend to a user one or more pages on the social networking system. The notification module 102 also can communicate with a data store 118. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the notification module 102 or page recommendation system 108 can be implemented in any suitable combinations.

The administrator activity probability module 104 can develop a machine learning model (or classifier) to determine a probability that an administrator of a page will take action on the page in response to receipt of an electronic notification. The machine learning model can be trained on various types of features. The types of features can include information relating to, for example, timing of electronic notifications last provided to the administrator, activities of the administrator on the page, interactions with the page by users who visit the page, profile of the page, etc. Once trained, the machine learning model can determine a probability that, in response to an electronic notification provided from the social networking system to the administrator, the administrator will take action on the page. The administrator activity probability module 104 is discussed in more detail herein.

The notification generation module 106 can create and transmit an inorganic electronic notification to an administrator of a page based on a probability that the electronic notification will trigger the administrator to take action on the page. Such an electronic notification can include a summary or other type of description (e.g., digest) of user interactions that have occurred with respect to the page. The electronic notification can include information about user interactions in which an administrator may have most interest. In some embodiments, the summary can include a count of a number of user interactions. The user interactions can include, for example, a number of likes by users of the page, a number of likes by users of a content item on the page, a number of views by users of the page, a number of comments by users on the page, a number of shares by the users of the page, etc. In some embodiments, the user interactions described in the electronic notification can cover a selected duration of time. For example, the user interactions described in the electronic notification can be a count of user interactions that occurred since the last electronic notification transmitted to the administrator or since a predetermined amount of time (e.g., prior month, prior week, prior day, etc.). The electronic notification can be any suitable type of electronic notification through the social networking system or another communication platform. In some instances, the electronic notification can be a notification provided to an account of the administrator on the social networking system or an account of the page on the social networking system. The electronic notification can take any suitable format, such as an email, text message, a post, etc. In some instances, both inorganic notifications and organic notifications can be provided to an administrator of a page.

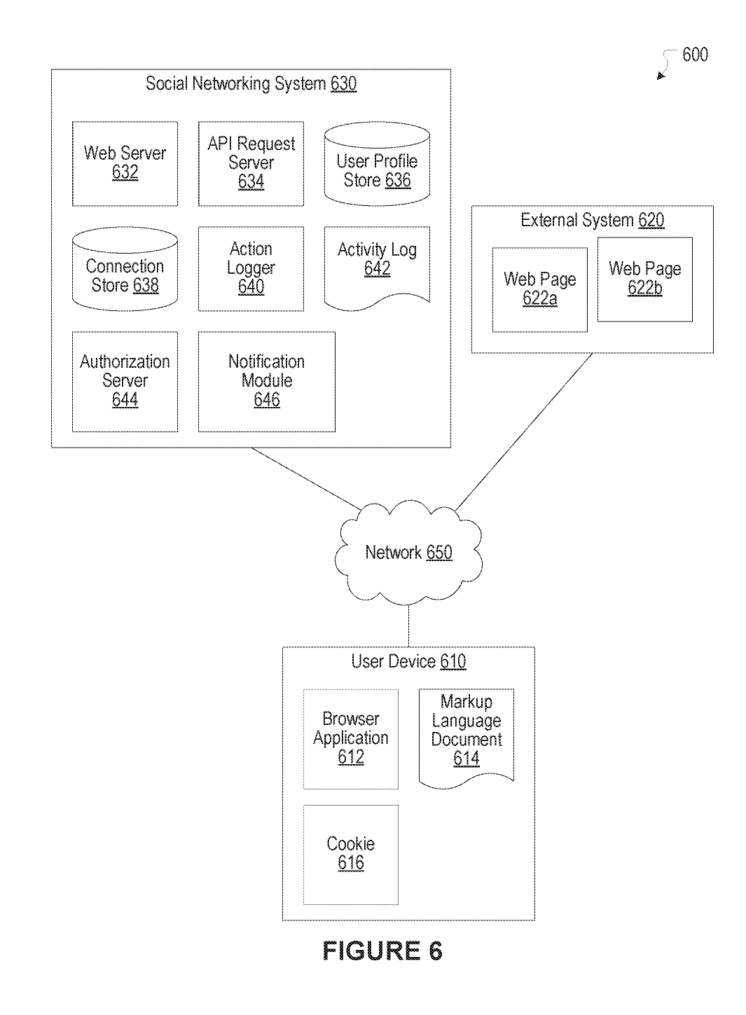

In some embodiments, the notification module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the notification module 102 can be, in part or in whole, implemented as software running on one or more computing devices or systems, such as on a server or a client computing device. For example, the notification module 102 can be, in part or in whole, implemented within or configured to operate in conjunction or be integrated with a social networking system (or service), such as a social networking system 630 of FIG. 6. As another example, the notification module 102 can be implemented as or within a dedicated application (e.g., app), a program, or an applet running on a user computing device or client computing system. In some instances, the notification module 102 can be, in part or in whole, implemented within or configured to operate in conjunction or be integrated with a client computing device, such as a user device 610 of FIG. 6. It should be understood that many variations are possible.

The data store 118 can be configured to store and maintain data relating to support of and operation of the notification module 102, such as training sets of data, a machine learning model, computed probabilities that an administrator will take action, etc. The data store 118 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the notification module 102 can be configured to communicate and/or operate with the data store 118.

As referenced above, the notification module 102 can communicate with and support the functionality of the page recommendation system 108 in some embodiments. The page recommendation system 108 can recommend one or more pages of interest for a user of the social networking system. The page recommendation module 108 can determine a rank score in relation to each candidate page for potential recommendation to the user. The rank score associated with a candidate page can be based at least in part on a probability that the user will perform a user interaction on the candidate page (page conversion) and a value of the user interaction. In some embodiments, the rank score associated with a candidate page can be based at least in part on the product of the probability that the user will perform a user interaction on the candidate page and the value of the user interaction.

The value of the user interaction on the candidate page can be based at least in part on a determination by the notification module 102. In this regard, the page recommendation system 108 can request a determination from the notification module 102 regarding a first probability that an administrator of a page will take action on the page based on a variety of factors with respect to a first time. The variety of factors can include, for example, any relevant considerations relating to the status or activities of the page or an administrator of the page. The page recommendation system 108 also can request a determination from the notification module 102 regarding a second probability that the administrator of the page will take action on the page with respect to a second time subsequent to the first time. The determination regarding the second probability can be based on, for example, an additional user interaction on the page (e.g., a like by the user) and an electronic notification provided to the administrator that accounts for the additional user interaction. In many instances, the additional user interaction on the page can result in the second probability being higher in value compared to the first probability. The page recommendation system 108 can compute a difference value between the second probability and the first probability. The difference value constitutes an increase in the probability that the administrator will become active as a result of the electronic notification. The difference value can represent the value of the additional user interaction.

Based at least in part on the value of the additional user interaction, the page recommendation system 108 can determine a rank score for each candidate page under consideration for recommendation to the user. Candidate pages having rank scores that satisfy a threshold rank score can be recommended to the user. The recommendation of a candidate page can be performed, for example, by providing to the user electronic access to the page or information about the page.

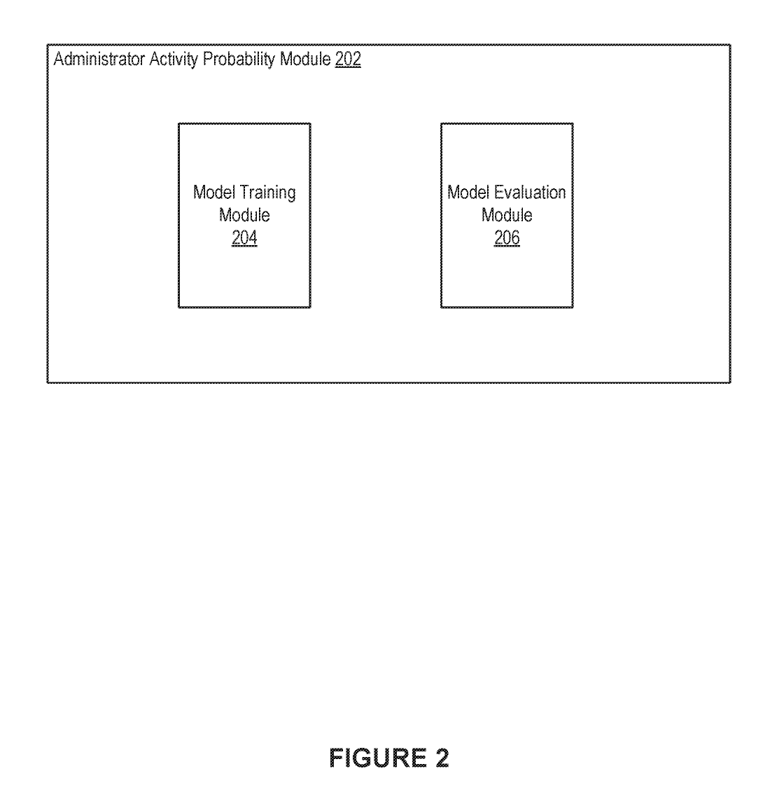

FIG. 2 illustrates an example administrator activity probability module 202, according to an embodiment of the present technology. In some embodiments, the administrator activity probability module 104 of FIG. 1 can be implemented with the administrator activity probability module 202. The administrator activity probability module 202 can include a model training module 204 and a model evaluation module 206.

The model training module 204 can develop a machine learning model to determine a probability that an administrator of a page will take action on the page in response to receipt of an electronic notification provided to the administrator. The machine learning model can be based on any suitable machine learning technique. In one embodiment, the machine learning model can be based on a gradient boosted decision tree technique.

The machine learning model can be trained on various types of features. Categories of features can include information relating to, for example, timing of electronic notifications last provided to the administrator, activities of the administrator on the page, interactions with the page by users who visit the page, profile of the page, etc. Features relating to timing of electronic notifications last provided to the administrator can include, for example, a number of days since an electronic notification was provided to an administrator of the page. Features relating to activities of the administrator on the page can include, for example, a number of days since any administrator of the page last took action on the page and a number of days since an electronic notification was provided to the particular administrator who is to potentially receive the electronic notification. Features relating to interactions with the page by users can include, for example, a number of views by users of the page, a number of likes of the page by users, and a number of likes of posts (or content items) published on the page by users. In some embodiments, other features that fall within the scope of the aforementioned feature categories or other feature categories can be used to train the machine learning model.

The machine learning model can be trained on positive samples and negative samples of a training set of data. In some embodiments, positive samples can include instances where an electronic notification created by the notification generation module 106 and provided to an administrator of a page prompted the administrator to take action on the page within a selected amount of time after receipt of the electronic notification. In some instances, the selected amount of time can be any suitable amount of time, such as a day, an hour, a week, etc. In some embodiments, negative samples can include instances where an electronic notification created by the notification generation module 106 and provided to the administrator of the page did not prompt the administrator to take action on the page within a selected amount of time after receipt of the electronic notification. In some embodiments, negative samples also can include instances where an electronic notification was not sent to the administrator but the administrator still took action on the page. Other positive samples and negative samples are possible. The machine learning model can be periodically or continuously retrained based on new training data.

The model evaluation module 206, based on the trained machine learning model, can determine in a particular instance a probability that, in response to receipt of an electronic notification, an administrator of a page will take action on the page within a selected amount of time. To determine a probability in the particular instance, values relating to some or all of the features relating to the instance can be provided to the machine learning model. The machine learning model can determine a probability score that quantifies a probability that, in response to receipt of an electronic notification by an administrator of a page, the administrator will take action on the page within a selected amount of time. In some embodiments, such a probability score can be determined for one or more administrators of a page. A probability threshold value can be applied to the determined probability scores. In some instances, the probability threshold value can be a selected probability score. In other instance, the probability threshold value can be a selected number of highest value probability scores. Probability scores that satisfy the probability threshold value can be identified. Electronic notifications can be provided to administrators of pages associated with the probability scores that satisfy the probability threshold value. The determinations of probability scores and related provision of electronic notifications, as described, can be performed at regular intervals (e.g., daily, weekly, etc.) or at intermittent times.

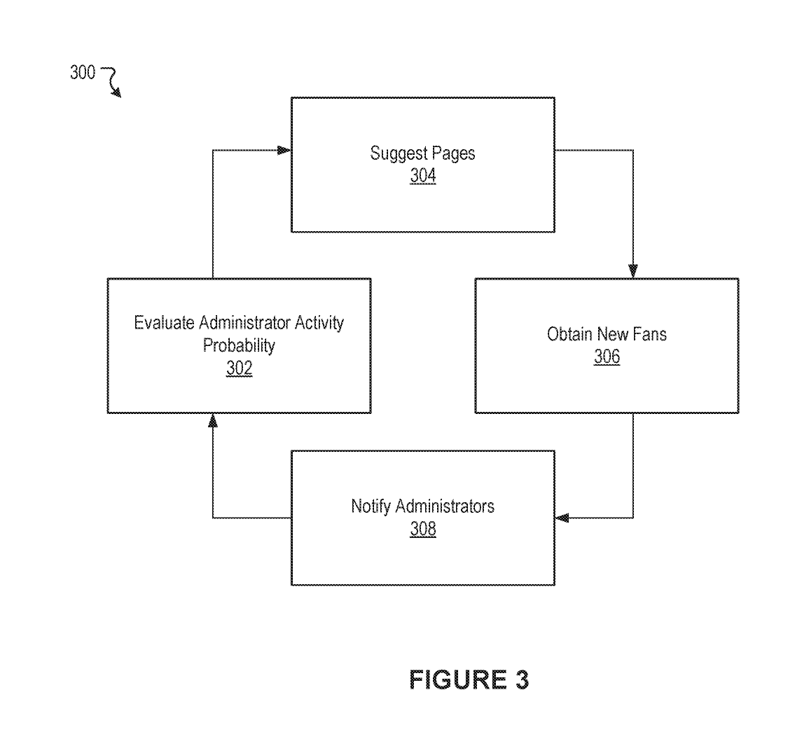

FIG. 3 illustrates an example functional block diagram 300 of an example application relating to suggestion of pages in a social networking system, according to an embodiment of the present technology. At block 302, an evaluation is made to determine a probability that an administrator of a candidate page will take action on the candidate page in response to receipt of an electronic notification that includes a description of user interactions with the candidate page. The determination of probability can be based on a machine learning model, as described in more detail herein. If a new, additional user interaction with the candidate page occurs (e.g., liking of the candidate page by a user) and an associated electronic notification is transmitted to the administrator, an increase in the probability that the administrator will become active on the candidate page as a result of the electronic notification is determined. The increase in the probability that the administrator will take action on the candidate page can constitute a value of the additional user interaction on the candidate page. The value of the user interaction on the candidate page can be used to make page suggestions. At block 304, pages can be suggested for a user of a social networking system. The suggestions can be based at least in part on rank scores associated with candidate pages for potential presentation to the user. A rank score can be based at least in part on a probability that the user will perform a user interaction on the candidate page and a value of the user interaction. The value of the user interaction can be determined, as discussed in connection with block 302. Candidate pages having rank scores that satisfy a threshold rank score can be presented to the user. Accordingly, when the increase in the probability that the administrator will take action on the page is relatively higher, the rank score for the associated candidate page will be higher. As a result of the higher rank score, the associated candidate page will enjoy a boost in being potentially selected as a suggested page for a user. At block 306, user interactions with each page presented to the user as a suggestion can occur. User interactions can include, for example, liking (fanning) a page by the user. At block 308, an electronic notification can be transmitted to an administrator of the page. The electronic notification can include a summary of user interactions that occurred on the page over a selected time interval. The electronic notification can prompt the administrator to take action on the page. Whether or not the administrator takes action on the page in response to the electronic notification can constitute new training data that can be used to retrain the machine learning model. The retrained machine learning model can be used in block 302 to determine a probability that an administrator of a candidate page will take action on the candidate page in response to receipt of an electronic notification, as discussed above.

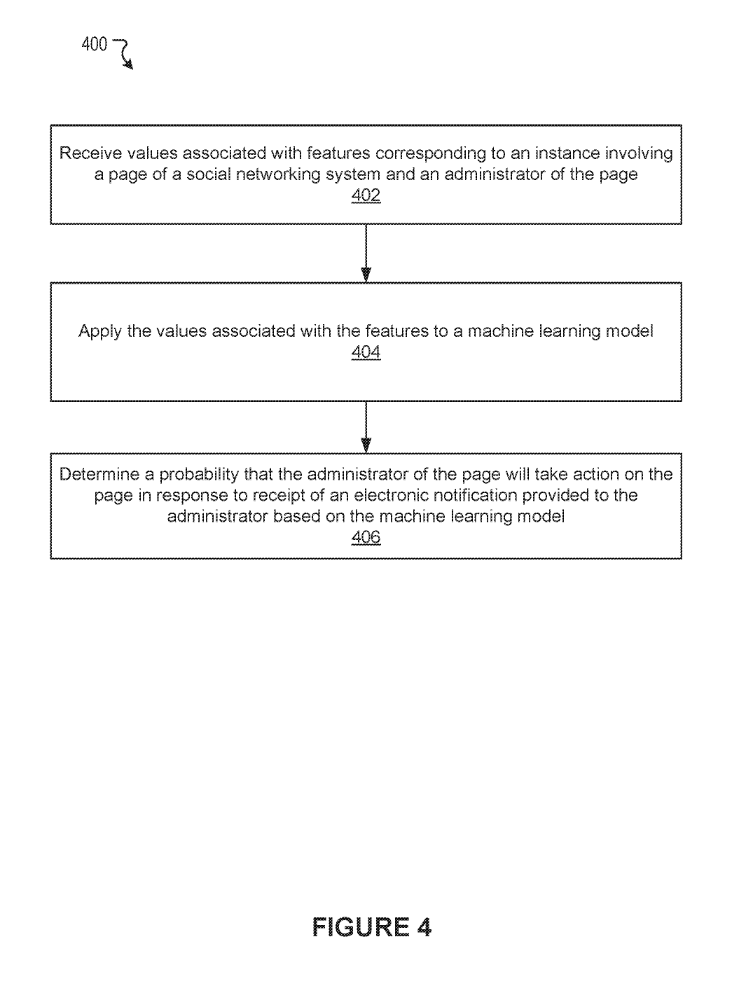

FIG. 4 illustrates an example method 400 to determine a probability that an administrator will take action on a page in response to receipt of an electronic notification, according to an embodiment of the present technology. It should be appreciated that there can be additional, fewer, or alternative steps performed in similar or alternative orders, or in parallel, in accordance with the various embodiments and features discussed herein unless otherwise stated.

At block 402, the method 400 can receive values associated with features corresponding to an instance involving a page of a social networking system and an administrator of the page. At block 404, the method 400 can apply the values associated with the features to a machine learning model. At block 406, the method 400 can determine a probability that the administrator of the page will take action on the page in response to receipt of an electronic notification provided to the administrator based on the machine learning model. Other suitable techniques that incorporate various features and embodiments of the present technology are possible.

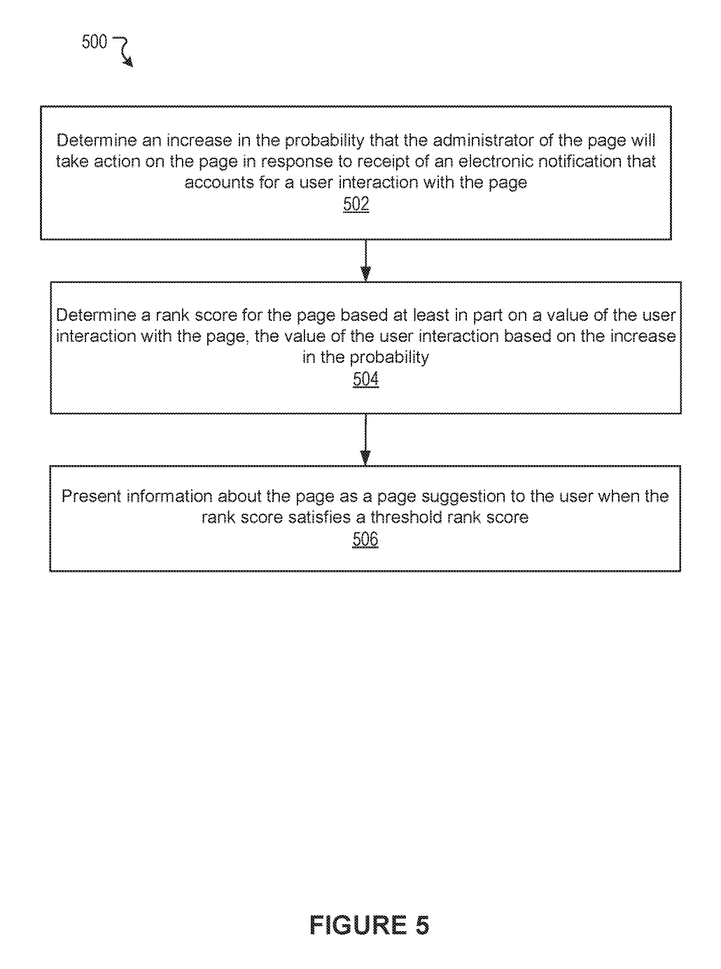

FIG. 5 illustrates an example method 500 to present a page suggestion to a user, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can determine an increase in the probability that the administrator of the page will take action on the page in response to receipt of an electronic notification that accounts for a user interaction with the page. At block 504, the method 500 can determine a rank score for the page based at least in part on a value of the user interaction with the page, the value of the user interaction based on the increase in the probability. At block 506, the method 500 can present information about the page as a page suggestion to the user when the rank score satisfies a threshold rank score. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a notification module 646. The notification module 646 can be implemented with the notification module 102, as discussed in more detail herein. In some embodiments, one or more functionalities of the notification module 646 can be implemented in the user device 610. In some embodiments, a page recommendation system (not shown) can be implemented with the page recommendation system 108, and can be included in the social networking system 630.

### Hardware Implementation

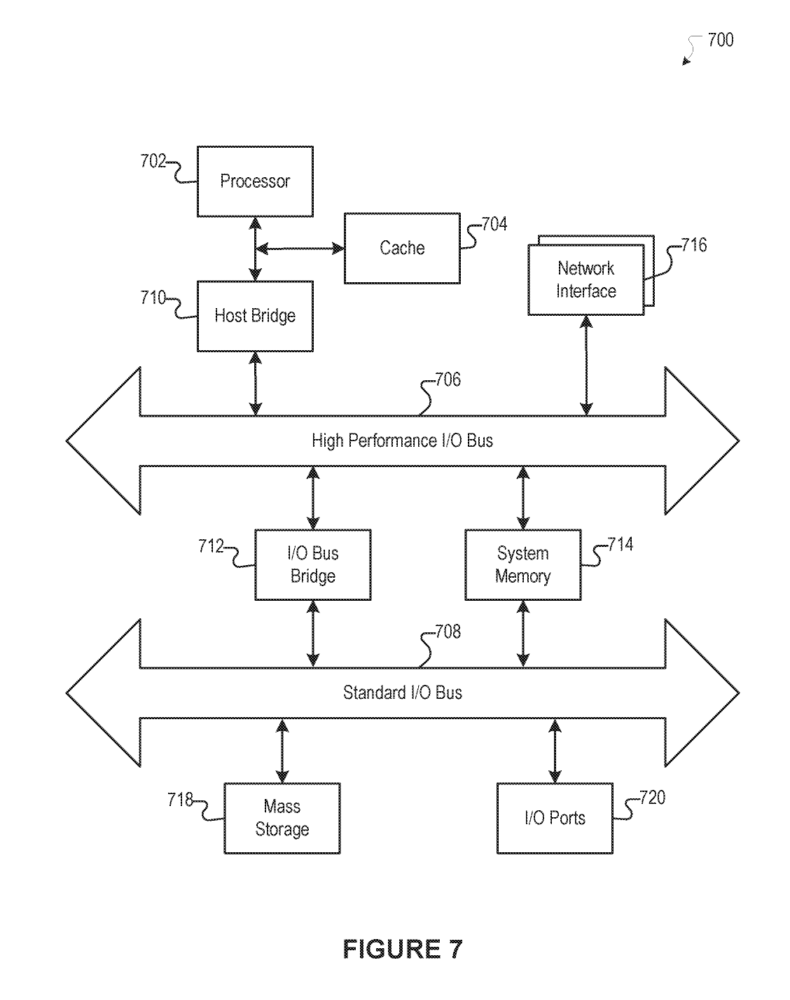

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, values associated with features corresponding to an instance involving a page of a social networking system and an administrator of the page;
applying, by the computing system, the values associated with the features to a machine learning model; and
determining, by the computing system, a probability that the administrator of the page will take action on the page in response to receipt of an electronic notification provided to the administrator based on the machine learning model.

2. The computer-implemented method of claim 1, further comprising:
training the machine learning model based on the features, categories of the features comprising at least one timing of notifications last provided to the administrator, activities of the administrator on the page, and user interactions with the page.

3. The computer-implemented method of claim 1, wherein the electronic notification comprises a summary of user interactions with the page during a selected duration of time.

4. The computer-implemented method of claim 3, wherein the summary comprises a count of user interactions, the user interactions comprising at least one of likes by users of the page, likes by users of a content item on the page, views by users of the page, and comments by users on the page.

5. The computer-implemented method of claim 1, wherein the probability that the administrator of the page will take action on the page is based on a selected amount of time after receipt of the electronic notification.

6. The computer-implemented method of claim 1, wherein the action taken by the administrator comprises at least one of posting content on the page, publishing a comment on the page, expressing satisfaction with content posted by a user on the page, and communicating with a user who liked the page.

7. The computer-implemented method of claim 1, wherein the machine learning model is based on a boosted decision tree technique.

8. The computer-implemented method of claim 1, further comprising:
determining an increase in the probability that the administrator of the page will take action on the page in response to receipt of an electronic notification that accounts for a user interaction with the page.

9. The computer-implemented method of claim 8, further comprising:
determining a rank score for the page based at least in part on a value of the user interaction with the page, the value of the user interaction based on the increase in the probability.

10. The computer-implemented method of claim 9, further comprising:
presenting information about the page as a page suggestion to the user when the rank score satisfies a threshold rank score.

11. A system comprising:
at least one processor; and
a memory storing instructions that, when executed by the at least one processor, cause the system to perform:
receiving values associated with features corresponding to an instance involving a page of a social networking system and an administrator of the page;
applying the values associated with the features to a machine learning model; and
determining a probability that the administrator of the page will take action on the page in response to receipt of an electronic notification provided to the administrator based on the machine learning model.

12. The system of claim 11, further comprising:
training the machine learning model based on the features, categories of the features comprising at least one timing of notifications last provided to the administrator, activities of the administrator on the page, and user interactions with the page.

13. The system of claim 11, wherein the electronic notification comprises a summary of user interactions with the page during a selected duration of time.

14. The system of claim 13, wherein the summary comprises a count of user interactions, the user interactions comprising at least one of likes by users of the page, likes by users of a content item on the page, views by users of the page, and comments by users on the page.

15. The system of claim 11, wherein the probability that the administrator of the page will take action on the page is based on a selected amount of time after receipt of the electronic notification.

16. A non-transitory computer-readable storage medium including instructions that, when executed by at least one processor of a computing system, cause the computing system to perform a method comprising:
receiving values associated with features corresponding to an instance involving a page of a social networking system and an administrator of the page;
applying the values associated with the features to a machine learning model; and
determining a probability that the administrator of the page will take action on the page in response to receipt of an electronic notification provided to the administrator based on the machine learning model.

17. The non-transitory computer-readable storage medium of claim 16, further comprising:
training the machine learning model based on the features, categories of the features comprising at least one timing of notifications last provided to the administrator, activities of the administrator on the page, and user interactions with the page.

18. The non-transitory computer-readable storage medium of claim 16, wherein the electronic notification comprises a summary of user interactions with the page during a selected duration of time.

19. The non-transitory computer-readable storage medium of claim 18, wherein the summary comprises a count of user interactions, the user interactions comprising at least one of likes by users of the page, likes by users of a content item on the page, views by users of the page, and comments by users on the page.

20. The non-transitory computer-readable storage medium of claim 16, wherein the probability that the administrator of the page will take action on the page is based on a selected amount of time after receipt of the electronic notification.
